(19) United States
(12) Patent Application Publication
(10) Pub. No.: US 2012/0030463 A1
(43) Pub. Date: Feb. 2, 2012

(54) DATA SECURE SYSTEM AND METHOD OF STORING AND READING DATA

(75) Inventors: HUNG-DA LI, TAIPEI COUNTY (TW); TIEH-CHIN HSIEH, TAOYUAN COUNTY (TW); YU-YIN KUO, TAIPEI COUNTY (TW)

(73) Assignee: ATP ELECTRONICS TAIWAN INC., TAIPEI (TW)

(21) Appl. No.: 12/944,084

(22) Filed: Nov. 11, 2010

(30) Foreign Application Priority Data
Jul. 28, 2010 (TW) 099124880

(51) Int. Cl. H04L 29/06

(52) U.S. Cl. 713/167

(57) ABSTRACT

A data secure system includes a computer host and a storage device having a certification signature. The computer host includes an encryption/decryption program, a data transceiver unit, an encryption module, and a decryption module. The data transceiver unit is communicatively connected to the storage device and an external device for receiving a raw data from the external device. The encryption module reads certification signature from the storage device via the encryption/decryption program, encrypts the raw data into an encryption data according to the certification signature, and stores the encryption data in the storage device. The decryption module reads the certification signature and the encryption data from the storage device via the encryption/decryption program and decrypts the encryption data according to the certification signature. Moreover, a method of storing and reading data is also provided.

This application claims the benefits of the Taiwan Patent Application Serial NO. 099124880 filed on Jul. 28, 2010, the subject matter of which is incorporated herein by reference.

### BACKGROUND OF THE INVENTION

1. Field of the Invention

The present invention relates to a data secure system and a method of storing and reading data, and more particularly to a data secure system, which encrypts/decrypts data according to a certification signature of a storage device, and a method of storing and reading data.

2. Description of the Prior Art

Due to the prevalence of computers and the Internet, many information are transmitted via the Internet. Take music and movies for example, before the Internet is popular, music and movies are mostly recorded in substantial storage devices such as discs for selling. After the Internet becomes popular, many companies start to put data on the internet server for users to download.

However, the biggest problem of transmitting information via the Internet is the infringement of copyrights. Thus, companies which value copyrights usually request users to purchase a username and a password for an internet server. Only when users key-in the username and password, can they login to the internet server and download data they need.

Nevertheless, since the data downloaded is not protected by any secure protection mechanism, some users may illegally transmit the information to other users after downloading, which jeopardizes the owner's copyrights.

Meanwhile, users possess the username and password are likely to share the username and password with other users, who do not pay. As a result, one account and password is shared by multiple users and the data is downloaded repeatedly.

### SUMMARY OF THE INVENTION

A data secure system and a method of storing and reading data is provided according to the present invention. The data secure system encrypts the data received by a computer host according to a certification signature included in a storage device and stores the data in the storage device. Therefore, the data is protected from being transmitted illegally.

A data secure system according to the present invention includes a storage device and a computer host. The storage device includes at least a certification signature. The computer host includes an encryption/decryption program, a data transceiver unit, an encryption module and a decryption module. The data transceiver unit is communicatively connected to the storage device and an external device to receive a raw data from the external device. The encryption module is communicatively connected to the data transceiver unit, wherein the encryption module reads the certification signature from the storage device by the encryption/decryption program and encrypts the raw data according to the certification signature so as to transfer the raw data into an encrypted data and saves the encrypted data in the storage device. The decryption module is communicatively connected to the data transceiver unit, wherein the decryption module reads the certification signature and the encrypted data from the storage device by the encryption/decryption program and decrypts the encrypted data according to the certification signature.

In one embodiment of the present invention, the certification signature is selected from the group of a product identifier (PID), a vendor identifier (VID) and a serial number (SN).

According to the present invention, the encrypted data is derived from transferring the raw data according to an encrypt/decrypt conversion table, and the encrypt/decrypt conversion table is generated by transferring the certification signature via a preset random number generator.

A method of storing data is further provided according to the present invention. The method is for a computer host to communicatively connect to a storage device, to encrypt a raw data to transfer the raw data into an encrypted data, and to store the encrypted data into the storage device. The data storing method of the present invention includes the steps of: presetting at least a certification signature in the storage device; installing an encryption/decryption program in the computer host; when receiving the raw data, obtaining the certification signature from the storage device by executing the encryption/decryption program via the computer host; transferring the raw data into an encrypted data by encrypting the raw data according to the certification signature via the encryption/decryption program; and sending the encrypted data to the storage device for storage.

In one embodiment of the present invention, when the encryption/decryption program encrypts the raw data according to the certification signature, the method further includes the steps of: obtaining an encrypt/decrypt conversion table by transferring the certification signature via a preset random number generator; and transferring the raw data into the encrypted data by comparing the raw data with the encrypt/decrypt conversion table.

A data reading method of is further provided according to the present invention. The method is for a computer host to read an encrypted data encrypted from a storage device, which includes t least a certification signature and which decrypts the encrypted data, and the encrypted data is encrypted according to the certification signature. The data reading method of the present invention includes the steps of: installing an encryption/decryption program in the computer host; when reading the encrypted data, executing the encryption/decryption program via the computer host to obtain the certification signature from the storage device; and decrypting the encrypted data according to the certification signature via the encryption/decryption program.

In one embodiment of the present invention, when the encryption/decryption program decrypts the encrypted data according to the certification signature, the method further includes: obtaining an encrypt/decrypt conversion table by transferring the certification signature via a preset random number generator; and decrypting the encrypted data by comparing the encrypted data with the encrypt/decrypt conversion table.

Compared with a conventional data download system, when the computer host of the data secure system of the present invention receives the raw data, the computer host encrypts the raw data into the encrypted data according to the certification signature stored in the storage device, and stores the encrypted data in the storage device. As a result, after users receive the raw data, they are not able to transmit the raw data to the other users. Besides, even if the other users obtain the encrypted data, they are not able to decrypt the encrypted data without the same certification signature applied during encryption and the encryption/decryption program. Thus, the data is protected securely according to the present invention.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic view of an embodiment of a data secure system according to the present invention;

FIG. 2 is a flow chart showing how to generate an encrypt/decrypt conversion table according to an embodiment of the present invention;

FIG. 3 is a flow chart showing a data storing method of the present invention; and

FIG. 4 is a flow chart showing a data reading method of the present invention.

### DETAILED DESCRIPTION OF THE PREFERRED EMBODIMENTS

The present invention relates to a data secure system and a method of storing and reading data, and more particularly relates to a data secure system, which encrypts/decrypts data according to a certification signature of a storage device, and a method of storing and reading data. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

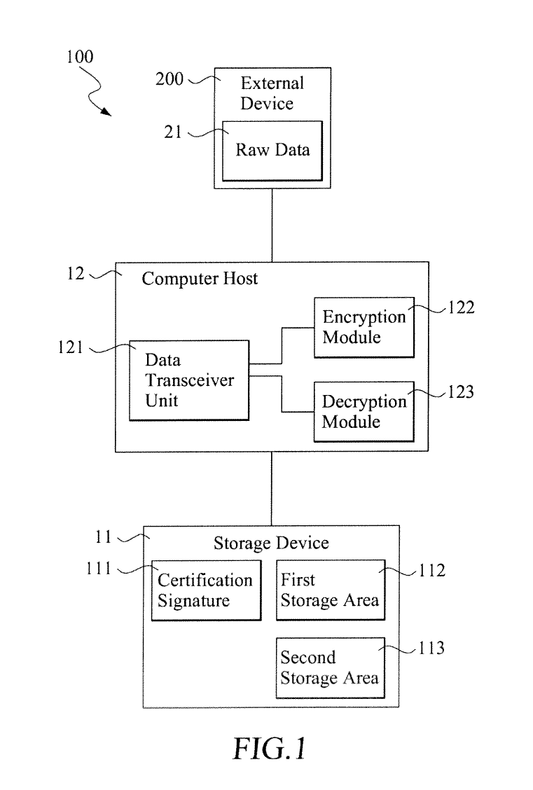

FIG. 1 illustrates a schematic view of an embodiment of a data secure system according to the present invention. A data secure system 100 of the present invention includes a storage device 11 and a computer host 12. The storage device 11 includes at least a certification signature 111. The computer host 12 includes an encryption/decryption program (not shown), a data transceiver unit 121, an encryption module 122 and a decryption module 123.

The data transceiver unit 121 is communicatively connected to the storage device 11 and an external device 200 to receive a raw data 21 from the external device 200.

The encryption module 122 is communicatively connected to the data transceiver unit 121, wherein the encryption module 122 reads the certification signature 111 from the storage device 11 by the encryption/decryption program and encrypts the raw data 21 according to the certification signature 111 so as to transfer the raw data 21 into an encrypted data (not shown) and saves the encrypted data in the storage device 11. Furthermore, In one embodiment of the present invention, the storage device 11 further includes a first storage area 112 and a second storage area 113, and the raw data 21 includes a storage location note. After the encryption module 122 obtains the encrypted data by encrypting the raw data 21, the encrypted data is stored in the group of the first storage area 112 and the second storage area 113 according to the storage location note. Moreover, the first storage area 112 is a hidden area while the second storage area 113 is a visible area, and the encrypted data is stored in the group of the first storage area 112 and the second storage area 113. When the encrypted data is stored in the first storage area 112 and users do not have a specific management interface and do not have the encryption/decryption program, they are not able to review the encrypted data stored in the first storage area 112. According to an embodiment of the present invention, to further enhance the security of data, the encrypted data is stored as read-only in the storage device 11 after the encryption module 122 encrypts the raw data 21 into the encrypted data.

The decryption module 123 is communicatively connected to the data transceiver unit 121, wherein the decryption module 123 reads the certification signature 111 and the encrypted data from the storage device 11 by the encryption/decryption program and decrypts the encrypted data according to the certification signature 111.

In one embodiment of the present invention, the certification signature 111 is selected from the group of a product identifier (PID), a vendor identifier (VID) and a serial number (SN). Particularly, when a combination of the group of a PID, a VID and a SN is the certification signature, the security of data is further improved due to the exclusivity of the SN.

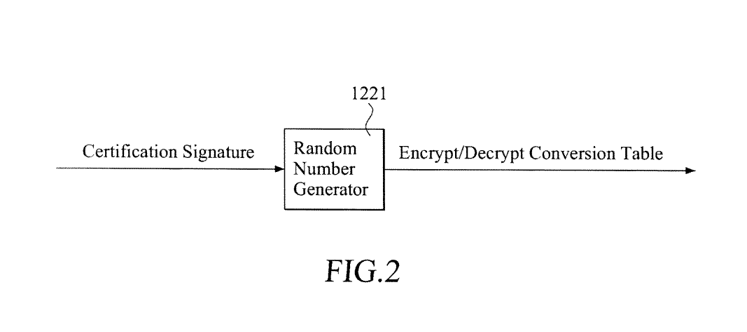

Referring to FIG. 2, a flow chart is shown how to generate an encrypt/decrypt conversion table according to an embodiment of the present invention. According to an embodiment of the present invention, the encrypted data is transferred according to an encrypt/decrypt conversion table, and the encrypt/decrypt conversion table is generated by transferring the certification signature 111 via a preset random number generator 1221. Likely, the encrypted data is decrypted according to the encrypt/decrypt conversion table.

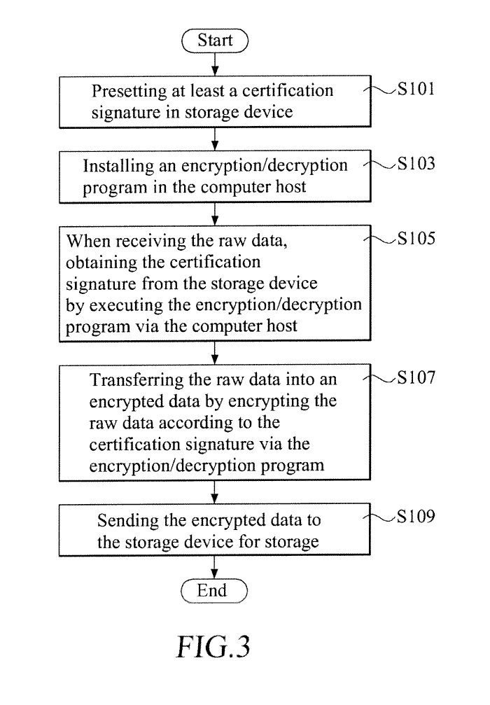

Referring to FIG. 3, a flow chart of a method of storing data according to of the present invention is shown. The method is for a computer host 12 to communicatively connect to a storage device 11, to encrypt a raw data 21 to transfer the raw data into an encrypted data, and to store the encrypted data into the storage device 11. The data storing method of the present invention includes:
S101: presetting at least a certification signature 111 in the storage device 11;
S103: installing an encryption/decryption program in the computer host 12;
S105: when receiving the raw data 21, obtaining the certification signature from the storage device 11 by executing the encryption/decryption program via the computer host 12;
S107: transferring the raw data 21 into an encrypted data by encrypting the raw data 21 according to the certification signature 111 via the encryption/decryption program, wherein when the encryption/decryption program encrypts the raw data 21 according to the certification signature 111, the data storing method of the present invention further includes the steps of: obtaining an encrypt/decrypt conversion table by transferring the certification signature 111 via a preset random number generator 1221 and transferring the raw data 21 into the encrypted data by comparing the raw data 21 with the encrypt/decrypt conversion table; and
S109: sending the encrypted data to the storage device 11 for storage.

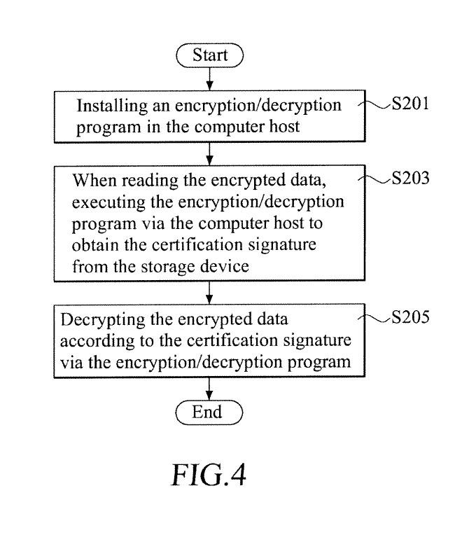

FIG. 4, a flow chart of a data reading method of the present invention is shown. The method is for a computer host 12 to read an encrypted data encrypted from a storage device 11 including at least a certification signature 111 and to decrypt the encrypted data, and the encrypted data is encrypted according to the certification signature. The data reading method of the present invention includes the steps of:
S201: installing an encryption/decryption program in the computer host 12;
S203: when reading the encrypted data, executing the encryption/decryption program via the computer host 12 to obtain the certification signature 111 from the storage device 11; and
S205: decrypting the encrypted data according to the certification signature 111 via the encryption/decryption program, wherein, according to an embodiment of the present invention, the method further includes obtaining an encrypt/decrypt conversion table by transferring the certification signature 111 via a preset random number generator 1221 when the encryption/decryption program decrypts the encrypted data, and decrypting the encrypted data by comparing the encrypted data with the encrypt/decrypt conversion table.

In conclusion, when the computer host 12 of the data secure system of the present invention receives the raw data 21, the computer host 12 encrypts the raw data 21 into the encrypted data according to the certification signature 111 stored in the storage device 11, and stores the encrypted data in the storage device 11. As a result, after users receive the raw data 21 via the computer host 12, they are not able to transmit the raw data 21 to the other users. Besides, even if the other users obtain the encrypted data, they are not able to decrypt the encrypted data without the storage device 11 including the certification signature 111 and the encryption/decryption program. Thus, the data is protected securely according to the present invention.

While the present invention has been particularly shown and described with reference to a preferred embodiment, it will be understood by those skilled in the art that various changes in form and detail may be without departing from the spirit and scope of the present invention.

What is claimed is:

1. A data secure system comprising:
a storage device including at least a certification signature; and
a computer host including an encryption/decryption program, the computer host further including
a data transceiver unit communicatively connected to the storage device and an external device to receive a raw data from the external device,
an encryption module communicatively connected to the data transceiver unit, wherein the encryption module reads the certification signature from the storage device by the encryption/decryption program and encrypts the raw data according to the certification signature so as to transfer the raw data into an encrypted data and saves the encrypted data in the storage device, and
a decryption module communicatively connected to the data transceiver unit, wherein the decryption module reads the certification signature and the encrypted data from the storage device by the encryption/decryption program and decrypts the encrypted data according to the certification signature.

2. The data secure system according to claim 1, wherein the certification signature is selected from the group of a product identifier (PID), a vendor identifier (VID) and a serial number (SN).

3. The data secure system according to claim 1, wherein the encrypted data is derived from transferring the raw data according to an encrypt/decrypt conversion table, and the encrypt/decrypt conversion table is generated by transferring the certification signature via a preset random number generator.

4. The data secure system according to claim 1, wherein the encrypted data is decrypted according to an encrypt/decrypt conversion table, and the encrypt/decrypt conversion table is generated by transferring the certification signature via a preset random number generator.

5. The data secure system according to claim 1, wherein the storage device includes a first storage area and a second storage area, the raw data including a storage location note, after the encryption module obtaining the encrypted data by encrypting the raw data, encryption module storing the encrypted data in the group of the first storage area and the second storage area according to the storage location note.

6. A data storing method for a computer host to communicatively connect to a storage device to encrypt a raw data to transfer the raw data into an encrypted data and to store the encrypted data into the storage device, the method comprising the steps of:
presetting at least a certification signature in the storage device;
installing an encryption/decryption program in the computer host;
when receiving the raw data, obtaining the certification signature from the storage device by executing the encryption/decryption program via the computer host;
transferring the raw data into an encrypted data by encrypting the raw data according to the certification signature via the encryption/decryption program; and
sending the encrypted data to the storage device for storage.

7. The method of storing data according to claim 6, wherein the certification signature is selected from the group of a product identifier (PID), a vendor identifier (VID) and a serial number (SN).

8. The method according to claim 6, wherein when the encryption/decryption program encrypts the raw data according to the certification signature, the method further comprises the steps of:
obtaining an encrypt/decrypt conversion table by transferring the certification signature via a preset random number generator; and
transferring the raw data into the encrypted data by comparing the raw data with the encrypt/decrypt conversion table.

9. A data reading method for a computer host to read an encrypted data encrypted from a storage device including at least a certification signature and to decrypt the encrypted data, the encrypted data being encrypted according to the certification signature, the data reading method comprising the steps of:
installing an encryption/decryption program in the computer host;
when reading the encrypted data, executing the encryption/decryption program via the computer host to obtain the certification signature from the storage device; and
decrypting the encrypted data according to the certification signature via the encryption/decryption program.

10. The method according to claim 9, wherein the certification signature is selected from the group of a product identifier (PID), a vendor identifier (VID) and a serial number (SN).

11. The method according to claim 9, wherein when the encryption/decryption program decrypts the encrypted data according to the certification signature, the method further comprises the steps of:
obtaining an encrypt/decrypt conversion table by transferring the certification signature via a preset random number generator; and
decrypting the encrypted data by comparing the encrypted data with the encrypt/decrypt conversion table.
